(19) United States
(12) Patent Application Publication
(10) Pub. No.: US 2004/0048027 A1
(43) Pub. Date: Mar. 11, 2004

(54) Honeycomb cores for aerospace applications

(76) Inventors: Michael W. Hayes, St. Charles, MO (US); Jeffrey E. DeGrange, St. Charles, MO (US); Christian V. Rice, St. Peters, MO (US); Jeffrey E. Polus, Hillsboro, IL (US)

Correspondence Address: John A. Artz, Artz & Artz, P.C., Suite 250, 28333 Telegraph Road, Southfield, MI, 48034, US

(21) Appl. No.: 10/236,361

(22) Filed: Sep. 6, 2002

(51) Int. Cl. B32B 1/00; B32B 3/00; B32B 3/12

(52) U.S. Cl. 428/53; 428/116; 428/118; 428/72; 428/73

(57) ABSTRACT

Honeycomb products and methods of manufacture thereof, particularly for aerospace applications. The honeycomb core products are made of a plastic material, such as a thermoplastic material, and preferably are made by a direct manufacturing process, such as stereo lithography, selective laser sintering, or fused deposition modeling. The cell sizes, shapes and wall thicknesses can be modified or varied throughout the product as desired. An interlocking structure is utilized to securely hold together adjacent honeycomb products.

### TECHNICAL FIELD

The present invention relates to honeycomb products, particularly honeycomb core products, for use in aerospace applications.

### BACKGROUND OF THE INVENTION

Honeycomb products are used for many applications today, particularly where weight reduction is desired without a significant impact on strength and durability. Honeycomb products are typically lighter in weight than corresponding solid products, use less material, are less expensive to manufacture and utilize, and provide satisfactory durability and strength for most applications. For specialized Radar Cross-Section (RCS) applications, such as for aerospace applications, honeycomb core products are typically custom made for the particular application. Honeycomb core products, for example, are typically used in the wings and ailerons of airplanes. This typically requires hard tooling, for cutting the core to an exact shape and/or bending it to a final form, and costly processing steps for applying the RCS absorbing material onto the core, and often results in inconsistent performance criteria. In addition, foam splice lines are utilized to attach pieces of honeycomb core portions together, which degrade the overall performance levels. Often, the honeycomb products require forming to the final shape which typically includes the use of heat to soften the cells. This usually leads to degradation in overall material structural properties and a weaker assembly. Honeycomb core products also typically require time consuming validation and verification testing, particularly relative to radar energy absorption.

### SUMMARY OF THE INVENTION

It is an object of the present invention to provide an improved honeycomb product, particularly for use in RCS aerospace applications. It is another object of the present invention to provide an improved method of fabrication of honeycomb core products, again particularly for aerospace applications.

It is a further object of the present invention to provide a honeycomb core product which is easier and less costly to manufacture, eliminates expensive processing steps, eliminates foam splice lines, and delivers a consistent product which will reduce or eliminate post production testing (e.g. validation and verification testing).

These and other objects are met by the present invention. The present invention provides a unique and beneficial honeycomb product which has significant advantages over known honeycomb products. In addition, the present invention provides a unique method of fabrication and interlocking of adjacent honeycomb portions.

The honeycomb core products are made of a plastic material by direct manufacturing techniques, such as stereo lithography, selective laser sintering, and fused deposition modeling. The products are manufactured in the precise shape desired and made from a moisture resistant material, such as a thermoplastic material. The cells of the honeycomb products can have any particular size and shape and can have varying sizes, shapes, and wall thicknesses throughout the product.

An internal interlock feature is provided which allows adjacent portions of the honeycomb products to be secured together without the use of foam splices or other methods conventionally used to bond honeycomb pieces together. The honeycomb core products can also be configured so that similar energy absorbing properties can be provided in any direction. The process creates a consistent product that reduces or eliminates the need for post-manufacture testing, such as validation and verification testing.

Other objects and features of the present invention will become apparent when viewed in light of the detailed description of the preferred embodiments when taken in conjunction with the attached drawings and appended claims.

### BRIEF DESCRIPTION OF THE DRAWINGS

FIG. 1 depicts an airfoil in which the present invention is incorporated;

FIG. 2 depicts a portion of the airfoil of FIG. 1;

FIG. 3 is an exploded view of a product incorporating the present invention;

FIG. 4 is an elevational view of a product incorporating the present invention;

FIG. 5 is a close up of a portion of FIG. 4;

FIG. 6 is a perspective view of a portion of the product shown in FIG. 4;

FIG. 7 is an elevational view of the product shown in FIG. 6; and

FIGS. 8-10 depict another embodiment of the invention.

### DESCRIPTION OF THE PREFERRED EMBODIMENT(S)

The present invention has particular use in the aerospace applications where lightweight honeycomb core products are commonly utilized. When honeycomb products are used today for aerospace applications, sheets of honeycomb material, which typically are made of Nomex or a treated paper product, are spliced, and glued together, and then cut and formed into the desired shape. Most of these honeycomb products are custom built and assembled for the particular application and need to be individually tested in order to meet specification and performance criteria. In particular, for use in aerospace applications, the honeycomb products need to be subjected to time-consuming validation and verification testing in order to meet the performance and operational requirements. These requirements include the ability to withstand extreme temperature ranges and provide certain strength and durability requirements, dielectric properties, and minimum moisture absorbing characteristics, while at the same time minimize weight and provide sufficient radar energy absorption, particularly in all directions. In order to meet these operational and performance criteria, hard tooling needs to be developed for each of the products, costly processing steps need to be performed, foam splice lines need to be utilized to attach adjacent pieces of honeycomb core product together, and design flexibility is limited.

In contrast, with the present invention, a relatively inexpensive cost effective design and consistent manufacturing process is utilized to fabricate unique and beneficial honeycomb core products which have particular use in aerospace applications. The honeycomb core has internal features and geometry that meet specified performance criteria. The acquisition and use of hard fabrication tooling is eliminated, and the cost of the honeycomb core assemblies is reduced by the elimination of several processing steps and with increased tolerance control. Consistency of the final product is increased with the use of a multiple gradient material leading to a reduction or elimination of current required testing. The unique interlocking joint mechanisms between adjacent honeycomb core products eliminate the use of foam splicing. The present invention produces a consistent product time-after-time which has significant design flexibility and provides required radar energy absorption.

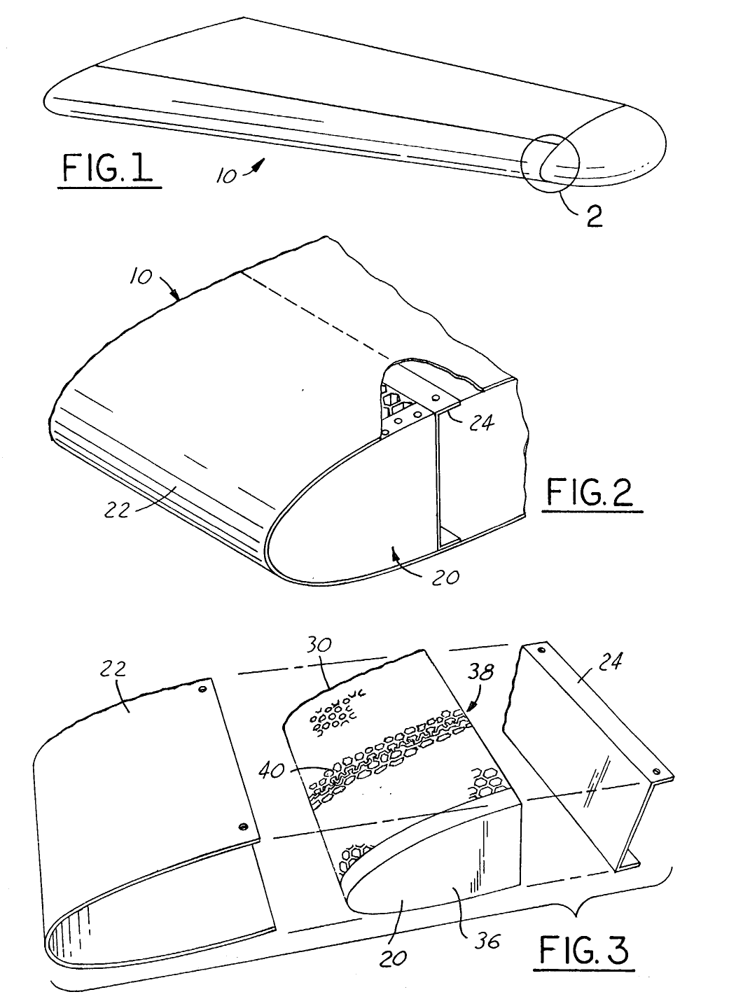

The honeycomb core products have particular use in the leading edges and ailerons for aircraft wings and airfoils. A representative aircraft wing is schematically shown in FIG. 1 and indicated generally by the reference numeral 10. A honeycomb core product in accordance with the present invention and shaped for such an application is shown in FIG. 2 and indicated generally by the reference numeral 20. The core product 20 is positioned on the leading edge of wing 10 and is covered by an outer skin member 22 and attached to a structural support member 24. An exploded view of this relationship is shown in FIG. 3. It is to be understood that only portions of the core, wing, skin and support members are shown in the drawings. In practice, the honeycomb core product can extend the full length of an aircraft wing or be positioned anywhere in an aircraft, spacecraft, or other structure where it is needed and desired. Thus, it is obvious that the shape and location of the honeycomb core product shown in the drawings and described herein are only representative or illustrative of the various shapes and uses of the present invention and are not meant to be limiting in any respect.

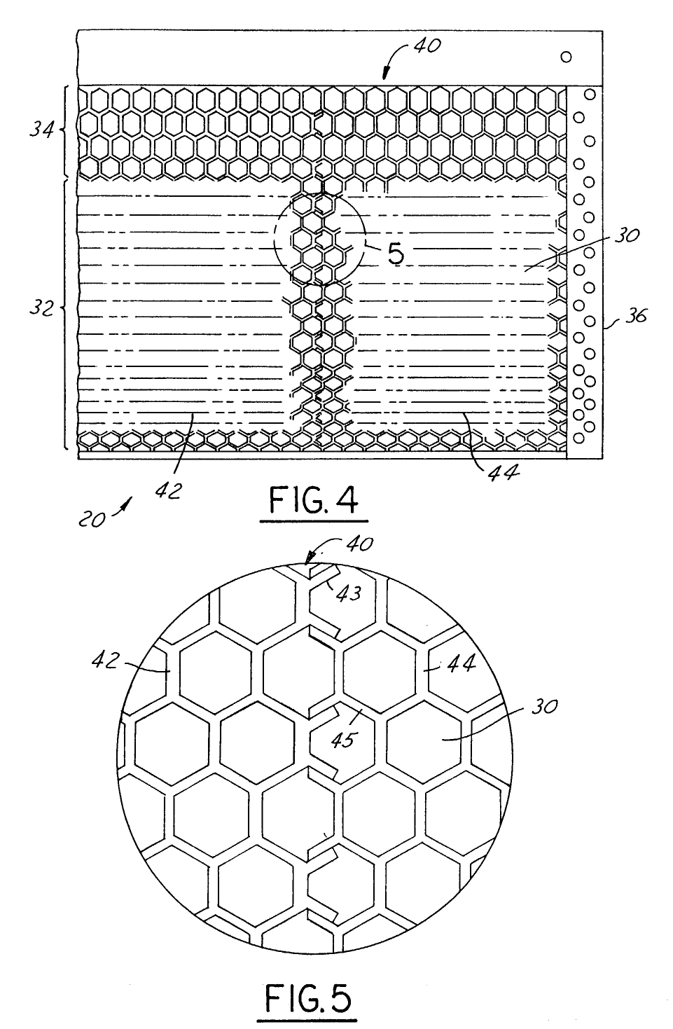

FIGS. 4 and 5 are enlarged views illustrating the size, type, and cell configuration of the honeycomb cells 30 in a preferred embodiment of the present invention. The honeycomb cells have a regular hexagon configuration 32 in one portion and with a certain wall thickness, and an elongated hexagon configuration 34 in another portion of the core 20, and with thicker wall surfaces.

The cells of the honeycomb core product in accordance with the present invention do not have to have a standard hexagon-shaped configuration. In this regard, the term “honeycomb” refers to any product which has an open configuration, regardless of the precise size and shape of the cells. For example, the cells could have a triangular shape, a square shape, a circular shape, or the like. A hexagon shape is commonly used due to its well characterized structural properties and mating configuration with adjacent cells.

The material for the honeycomb core product 20 in accordance with the present invention can be any plastic material, such as nylon, and preferably is a thermoplastic material. A RCS absorbing material is embedded into the core product. The product is also designed to have the particular shape desired for the application. In this regard, it is not necessary to glue several flat sheets of traditional honeycomb core material together and form and cut it to the required shape.

In accordance with the present invention, direct manufacturing techniques, such as stereo lithography, selective laser sintering, and fused deposition modeling can be utilized to form the present invention. With these processes, digital CAD files are created for the particular size, shape, and cell configuration desired, and the products are directly manufactured using the SLA, SLS, of SDM technology. These techniques are shown, for example, in “Rapid Prototyping and Tooling State of the Industry,” The Wohlers Report (2002).

With the use of these technologies, and the use of plastic materials, the honeycomb core products 20 are made from moisture resistant materials and thus have the requisite lack of moisture absorption. Also, with the use of digital CAD processing, product design manufacturing flexibility is secured. Geometry freedom can be utilized to meet the specific requirements of the product. The variables include cell configurations, cell wall thickness, cell sizes, and the like.

Also in accordance with the present invention, built-in close-outs are possible, together with elimination of Fay sheets (that is surface to surface bonding).

The honeycomb core products 20 are also isotropic. This means that the products can be configured so that the same energy absorbing products can be achieved in any direction. The products can also be fabricated and designed to meet all of the requisite performance and operational requirements. These requirements include usage at certain temperature ranges, certain strength characteristics, certain dielectric characteristics, certain weight requirements, and certain durability requirements. The requirements are met by introducing composite material directly to the base material in the build sequence, with the RCS absorbing material being embedded in the core. The RCS requirements can then be tailored by altering cell wall thickness, in the shape of the 3D cell or by varying the amounts of the RCS absorbing material within the base material during the build.

With the present invention, it is also unnecessary to perform timeconsuming testing, such as verification and validation testing, on each of the products as they are produced. The present invention delivers a consistent product time after time. Once all of the operational and performance requirements are met, subsequent products having the same characteristics can be provided without additional trouble or expense.

When the honeycomb core products 20 are manufactured, it is not uncommon to include a flat end surface, such as surface 36, on one or both ends of each piece. The end surfaces 36 provide locations and surfaces for mating with adjacent structural members and for attaching the cores to them. Similarly, it is typical to provide a flat back surface 38 on the honeycomb cores 20 so they can be mated with and securely attached to corresponding structural support members, such as support member 24.

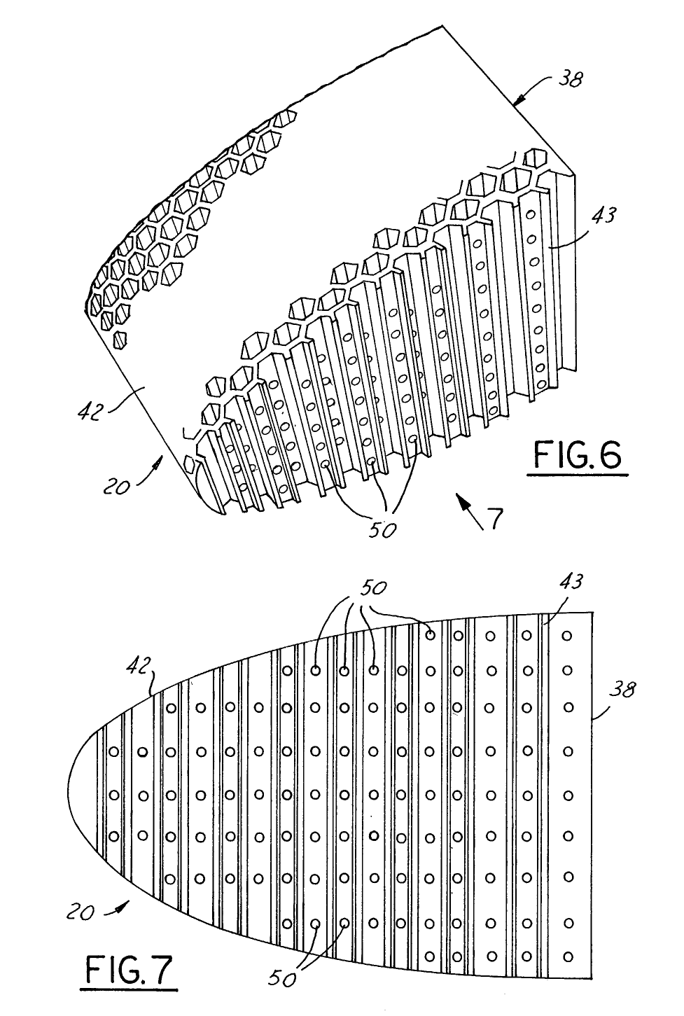

In order to join two adjacent pieces of honeycomb material together, an interlocking joint is preferably provided. This is referred to be the reference numeral 40 in the drawings. As shown in FIGS. 4 and 5, a series of three-sided members 43 are provided along the mating edge of one honeycomb core section 42 and a mating series of five-sided members 45 are provided along the mating edge of honeycomb core section 44. The two sections 42 and 44 are interlocked together in a longitudinal direction. The interlocking joint structure, at least one-half thereof, is also illustrated in FIGS. 6 and 7 which depict the honeycomb structure and end view of section 42. Once the two portions 12 and 14 are interlocked together, they are tightly secured together without additional bonding or adhesives. In this regard, foam splicing to bond honeycomb core pieces together is not required with the present invention.

A plurality or series of openings or holes 50 are typically provided along the walls of the honeycomb structures, as shown in FIGS. 6 and 7. These openings which can be of any size and shape and decrease the amount of material utilized together with the resultant cost and weight of the cores. The openings also allow faster and proper drainage of any fluids which are utilized during formation of the honeycomb cores, such as, for example, SLA procedures are utilized to manufacture the products.

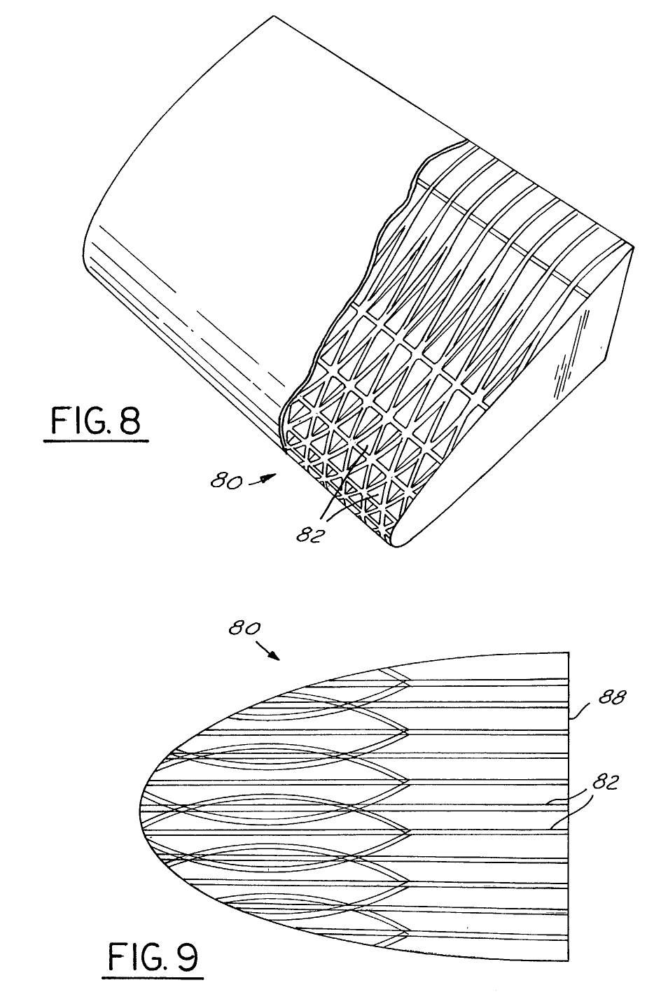

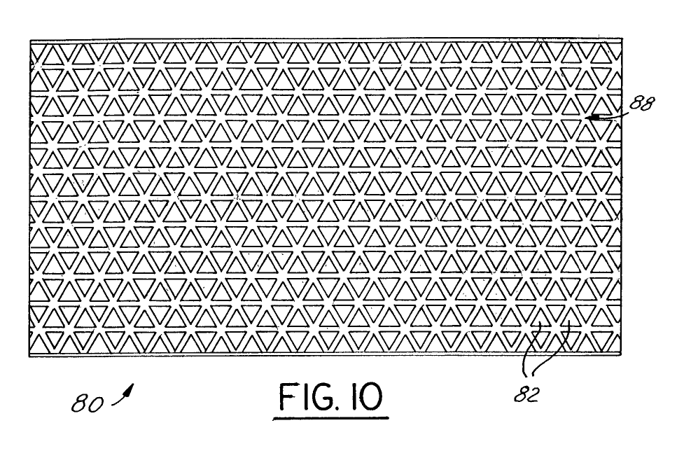

An alternate embodiment of the present invention is shown in FIGS. 8-10 and referred to generally by the reference numeral 80. FIG. 8 is a perspective view of the alternate embodiment 80, FIG. 9 is a side elevational view, and FIG. 10 is an elevational view showing the rear or back surface 88 of the honeycomb core product 80. In this embodiment, the honeycomb core cells 82 have a triangular cross-section and are oriented in a direction 90° to the direction of the cells 30 in the embodiment shown in FIGS. 1-7. In addition, the cells 82 are curved in a longitudinal direction as shown in FIG. 8.

The differences between the two embodiments shown and described herein illustrate the wide variety of sizes, shapes and orientations of honeycomb cores and honeycomb cells which are possible with the present invention. The selection of the specific size, shape and orientation of cells can depend on a number of factors, such as the size and shape of the honeycomb core products, the specific application in which the products are to be utilized, the strength, local stiffness, tailoring, weight provisions, subsystem routing requirements, and the like. A triangular-shaped cell structure, for example, can add additional strength to the product and can increase the absorption of radar energy.

Although two specific embodiments of the present invention are disclosed and described herein, it is obvious that other honeycomb core configurations can be utilized in accordance with the present invention. In this regard, the cell configurations can be of various sizes and shapes and with various wall thicknesses. In addition, different sized cells can be utilized throughout the extent of the honeycomb core product. It is also possible to change the cross-sectional shapes of the cells in a particular honeycomb product, if desired.

The honeycomb core products can also be made of any material, preferably a thermoplastic material, which meets the operational and performance criteria desired.

The honeycomb core products also have a number of different uses in industrial applications, and particularly in aerospace applications. For example, honeycomb products can be used for door structures, fuselage structures, floor structures, and the like, as well as wing structures specifically identified above.

While particular embodiments of the invention have been shown and described, numerous variations and alternative embodiments will occur to those skilled in the arm. Accordingly, it is intended that the invention be limited only in terms of the appended claims.

What is claimed is:

1. A honeycomb core product having a plurality of cell members, said core product being made by a manufacturing technique selected from the group consisting of stereo lithography, selective laser sintering, fused deposition molding, and combinations thereof.

2. The honeycomb core product as set forth in claim 1 wherein said cell members have a hexagon cross-sectional configuration.

3. The honeycomb core product as set forth in claim 1 wherein said cell members have a triangular cross-sectional configuration.

4. The honeycomb core product as set forth in claim 1 wherein said cell members have a curved longitudinal axis.

5. The honeycomb core product as set forth in claim 1 wherein said cell members comprise a first portion having a first cross-sectional size and shape and a second portion having a second cross-sectional size and shape.

6. The honeycomb core product as set forth in claim 1 wherein said honeycomb core product has a plurality of interlocking members along at least one end thereof.

7. The honeycomb core product as set forth in claim 1 wherein said honeycomb core product has at least two sections interlocked together.

8. The honeycomb core product as set forth in claim 1 wherein said honeycomb core product is made from a plastic material.

9. The honeycomb core product as set forth in claim 1 wherein said honeycomb core product includes an embedded RCS absorbing material.
